(19) United States
(12) Patent Application Publication
(10) Pub. No.: US 2018/0330318 A1
(43) Pub. Date: Nov. 15, 2018

(54) Systems and Methods for Dynamically Updating Stored Lists Based on Contemporaneous Location Data Associated with Client Devices

(71) Applicant: Walmart Apollo, LLC, Bentonville, AR (US)

(72) Inventor: Shyam Kumar Alaparthy, Bentonville, AR (US)

(21) Appl. No.: 15/978,898

(22) Filed: May 14, 2018

Related U.S. Application Data
(60) Provisional application No. 62/506,217, filed on May 15, 2017.

(51) Int. Cl. G06Q 10/08; H04W 4/021

(52) U.S. Cl. CPC G06Q 10/087; H04W 4/021

(57) ABSTRACT

Exemplary embodiments of the present disclosure are related to data structure management systems and methods. a data structure management system receives a first list including a plurality of desired items, and monitors a current location of a client device of a user based on a location signal received from the client device. When at least one desired item is determined as unavailable in the particular facility, the system automatically generates a second list including the unavailable items. The system further re-sequence the first list based on a location of the client device and locations of the available items and transmit the re-sequenced list and the locations of the available items to the client device to activate location tracking.

### CROSS REFERENCE TO RELATED APPLICATIONS

This application claims priority to U.S. Provisional Application No. 62/506,217, filed on May 15, 2017, the disclosure of which is incorporated by reference herein in its entirety.

### BACKGROUND

In large environments, it can be difficult to track item availability information and locations of items. For example, when a user is looking for items in a facility, it can be difficult for the user to know whether the desired item is available or not in this facility. Even if the desired item is available, it can also be difficult for the user to know where the item is.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an exemplary data structure management system in accordance with embodiments of the present disclosure.

FIG. 2A is a diagram illustrating a geographic boundary that can be implemented in accordance with exemplary embodiments.

FIG. 2B is a diagram illustrating various geographic boundaries that can be implemented in accordance with exemplary embodiments.

FIG. 3 is a block diagram of an exemplary a distributed environment for implementing a data structure management system in accordance with embodiments of the present disclosure.

FIG. 4 is a block diagram of an exemplary computing device that may be used to implement exemplary embodiments of the data structure management system.

FIG. 5 is a flowchart illustrating an exemplary process implemented by a data structure management system in accordance with embodiments of the present disclosure.

FIG. 6 is a flowchart illustrating another exemplary process implemented by a data structure management system in accordance with embodiments of the present disclosure.

### DETAILED DESCRIPTION

Exemplary embodiments of the present disclosure are related to systems and methods for dynamically updating and reordering a list of items based on contemporaneous location data associated with a current location of a client device associated with the list of items.

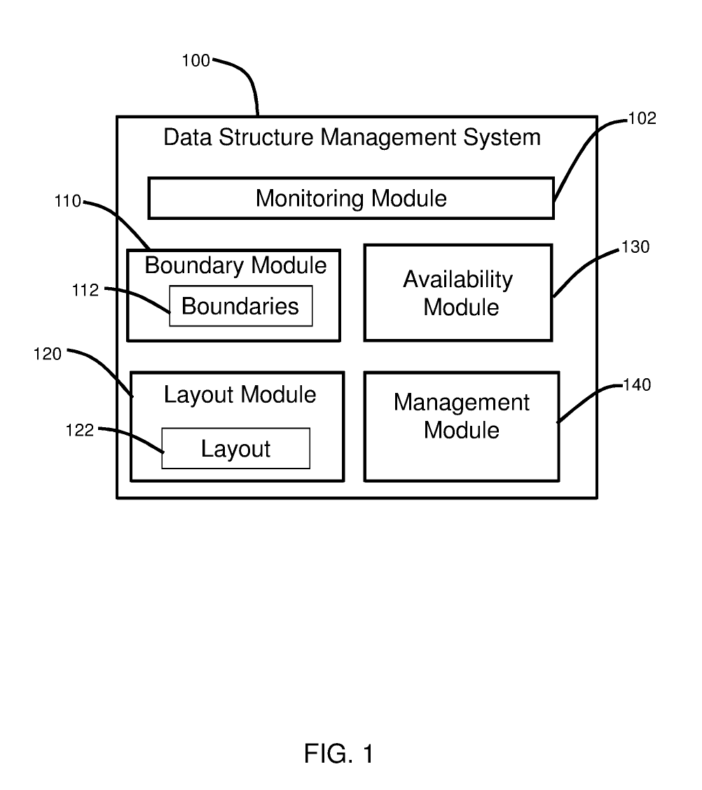

FIG. 1 is a block diagram of an exemplary data structure management system 100 that can be implemented in a distributed system and/or environment. The data structure management system 100 can include a boundary module 110, a layout module 120, an availability module 130, a management module 140, and a monitoring module 102. In exemplary embodiments, the system 100 can be configured to receive contemporaneous location data from client devices and to output a queue position of an item list based on the location data, including, for example, an electronic notification to check the availability of the items in the item list, or prioritize the of the items in the item list based on the location data.

The monitoring module 102 can be programmed and/or configured to electronically monitor whether a user with a client device enters or exits a geographical area or boundary 112. The monitoring module 102 can determine whether client devices associated with users that have item lists maintained by the system are within the boundaries 112 by interacting with the management module 140. For example, the monitoring module 102 can be programmed and/or configured to be in communication with a client device associated with the user based on the user identifiers maintained by the system 100. For example, a user can carry a mobile device, such as a cell phone, tablet, and/or any other suitable device that is configured for wireless communication and can be programmed and/or configured for directly and/or indirectly communicating with the system 100. In some embodiments, the mobile device can include GPS functionality such that the location of the mobile device can be determined using GPS tracking. When the mobile device enters the boundaries 112, as determined by the GPS tracking, the mobile device can send an electronic message notifying the system 100 of the user's presence. In another example, the mobile device can includes beacon generating devices that periodically transmit beacon signals to notify the system 100 of the user's presence.

Upon programmatically detecting that the user is within the boundary 112, the monitoring module 102 can be programmed and/or configured to generate one or more electronic notifications to the system and the system can perform one or more processing tasks in response to the notifications. For example, the monitoring module 102 can be programmed and/or configured to send a notification to the client device indicating that the system 100 received the item list and that some items in the list are available and some other items are unavailable. In some embodiments, the monitoring module 102 can display an alert on an operator terminal at the physical location of the distributed system and/or can send an alert to a handheld device carried by an employee of the physical location of the distributed system to informing the user's arrival.

The boundary module 110 can be programmed and/or configured to implement one or more geographical boundaries 112. The geographic boundaries 112 can define a geographic perimeter encompassing a geographical area (e.g., by specifying a set of longitudes and latitudes or based on a range of detectors, sensors, or receivers). The geographical boundaries 112 can be used by the system 100 to provide a geographical area within which a client device can be automatically detected by the monitoring module 102 based on contemporaneous location data received by the system 100, as described in more detail below. In some embodiments, the boundaries 112 can coincide with and/or be coextensive with physical boundaries, such as, for example, the exterior walls of a building.

In some embodiments, the boundary module 110 can be programmed and/or configured to determine the boundaries 112 based on a range of one or more wireless access points (e.g., wireless routers) that can be geographically distributed and can be programmatically monitored by the boundary module 110. The combined coverage of the wireless access points can define the geographic area or areas forming the boundary or boundaries. When a client device is within the range of one or more of the wireless access points, the wireless access points can detect the client device (e.g., based on one or more messages sent by the client device) and can send an electronic message to the system 100 including location data associated with the user.

In some embodiments, the boundaries 112 can be established using a geo-fence. A geo-fence is a geographic boundary that can be defined according to a geographic map. A perimeter of the geo-fence can be defined based on a GPS-based geographical area. In some embodiments, the boundary module 110 can be programmed and/or configured to allow an operator to define a geographical area to be included within a geo-fence. As one example, the boundary module 110 can be programmed and/or configured to allow the operator to define a geographical area by allowing the operator to specify longitudinal and latitudinal coordinates to define the geo-fence and/or by allowing the operator to overlay the GPS-based geo-fence on an electronically generated geographical map. When a user's GPS enabled mobile device enters or exits a geo-fence (e.g., crosses the perimeter of one of the boundaries), a notification that the user has entered or exited a geo-fence can be generated by the user's mobile device and can be sent to the system 100 to indicate that the user has entered or exited the geographical area.

The layout module 120 can be programmed and/or configured to implement one or more layout information map 122 of the distributed system. The layout module 120 can includes a data structure, identified as layout information map, indicative of positions of items within the distributed system. In an example application, the distributed system can be a retail entity.

The availability module 130 can be programmed and/or configured to retrieve item availability data in the distributed system based on the items associated with an item list stored in the system. For example, the item availability data can include availability of an item in the distributed system, quantities of the available items in the distributed system, etc.

The management module 140 can be programmed and/or configured to maintain a record of item lists and associated user identifiers. In an example application, when a user places an order for an item, the order along with some identifying characteristic (e.g., user's name, address, and/or cell phone number) can be programmatically received by the management module 140. In another example application, when some items in a user's list are determined as unavailable, the unavailable items along with the customer identifying characteristic can be programmatically received by the management module 140.

In an example application, the system can be implemented to fulfill the in-store unavailable items from the pre-existing electronic shopping list (ESL) in the mobile device along with the provision of sequencing the available items within the shopping list based on their aisle location and integrating into a store map to quickly locate the items within the store. The unavailable items in the ESL can be either shipped to a selected address or picked-up at a chosen address and billed directly to the user's credit card on the account. In accordance with embodiments of the present disclosure, the data structure management system not only plots the in-store available items on a store layout map, but also automatically adds the unavailable items to the online shopping list such that the user can place an order, or automatically place an order of the unavailable items according to the user profile and preference such that the unavailable items can be shipped directly to the user's address.

In accordance with embodiments of the present disclosure, the system can use “Geo Fencing” technology or “Beacon” technology in the store locations to identify the user's presence in the stores. Further, the system can automatically update the user's online shopping list based on the user's in-store location presence and the item unavailability.

In accordance with embodiments of the present disclosure, the data structure management system can access and integrate all the needed services, including store layout, users shopping list on the mobile APP, user locations using geo fencing, etc.

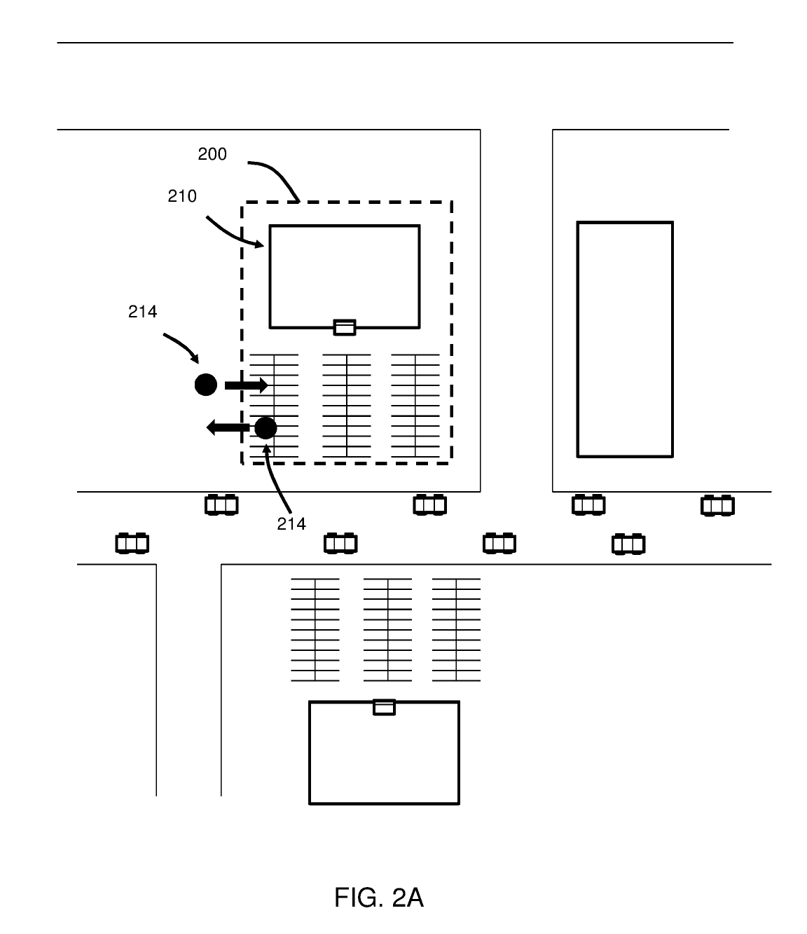

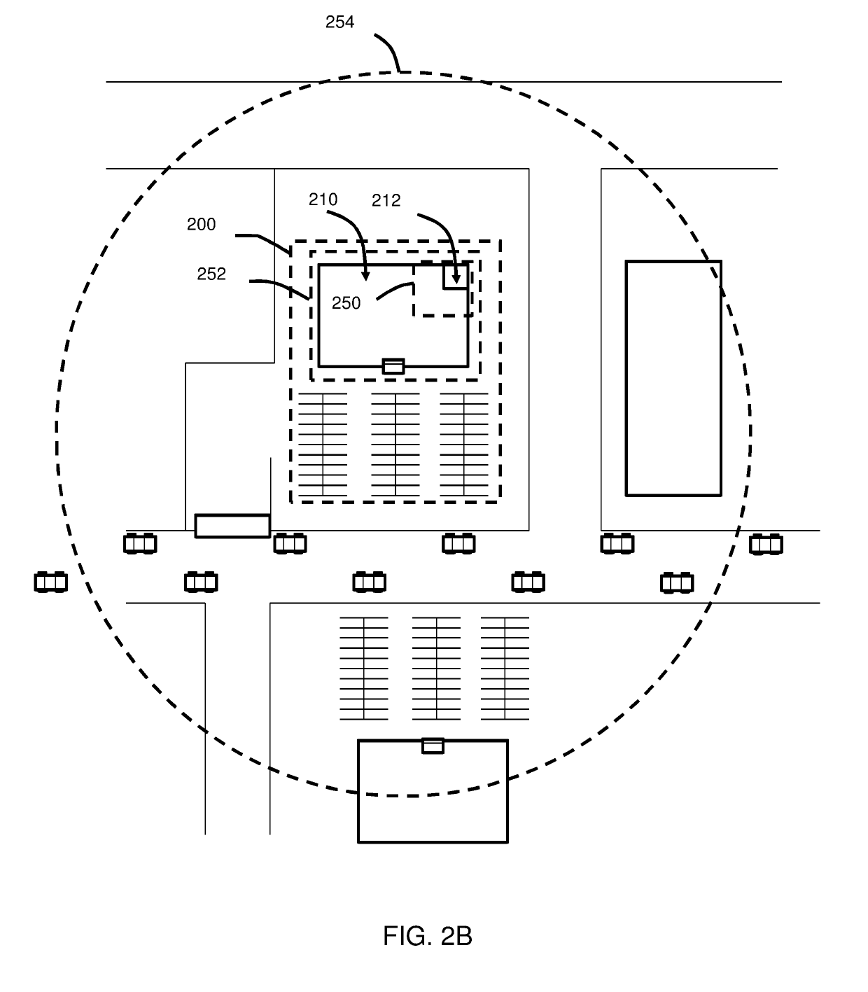

FIG. 2A is a diagram illustrating a geographic boundary 200 that can be defined by the data structure management system 100 in accordance with exemplary embodiments of the present disclosure. A physical location 210 of a distributed system can implement an exemplary embodiment of the monitoring module 102 using the boundary 200 via the data structure management system 100. For example, in the present embodiment, the boundary 200 can be rectangular and encompasses the physical location 210 of the distributed system. In exemplary embodiments, the boundary 200 is implemented and/or used by an embodiment of the system 100 to determine when a user 214 enters the boundary 200 and/or exits the boundary 200.

While a single boundary 200 is shown in FIG. 2A, those skilled in the art will recognize that multiple boundaries can be implemented in accordance with exemplary embodiments of the present disclosure. For example, as shown in FIG. 2B, a boundary 250 can encompass a portion 212 of the distributed system 210, a boundary 252 can encompass the building, the boundary 200 can encompass the lot, and the boundary 254 can encompass a radius surrounding the physical location of the distributed system such that a user's movement into and out of any of the boundaries can be detected and used by the system 100.

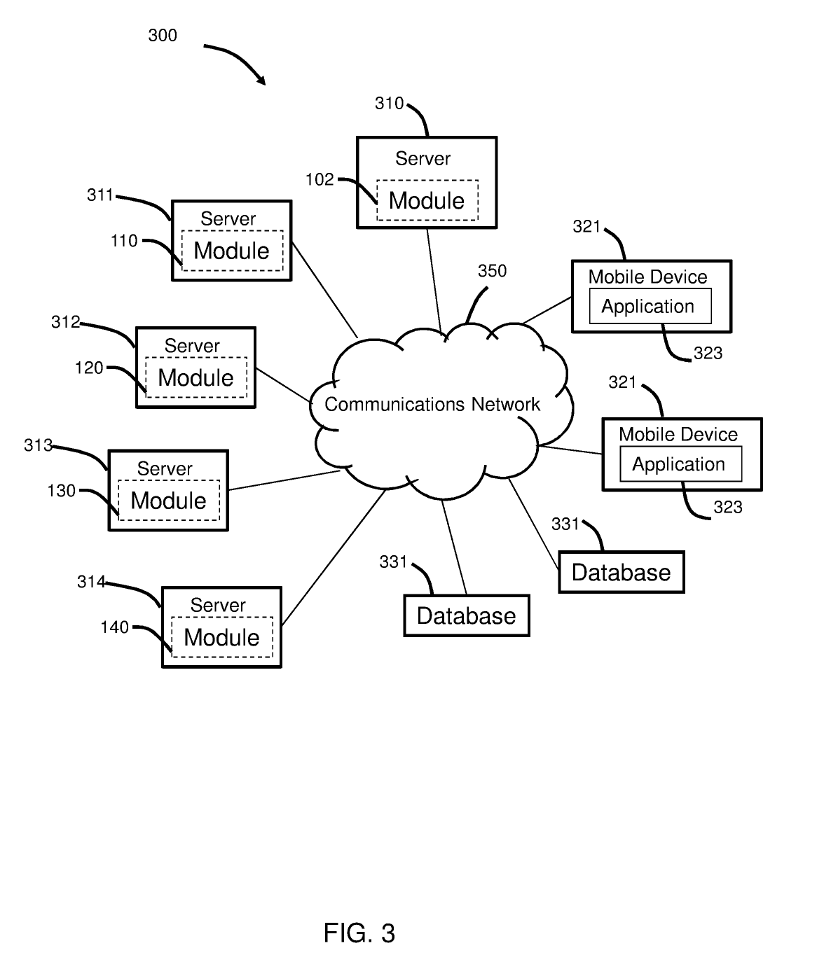

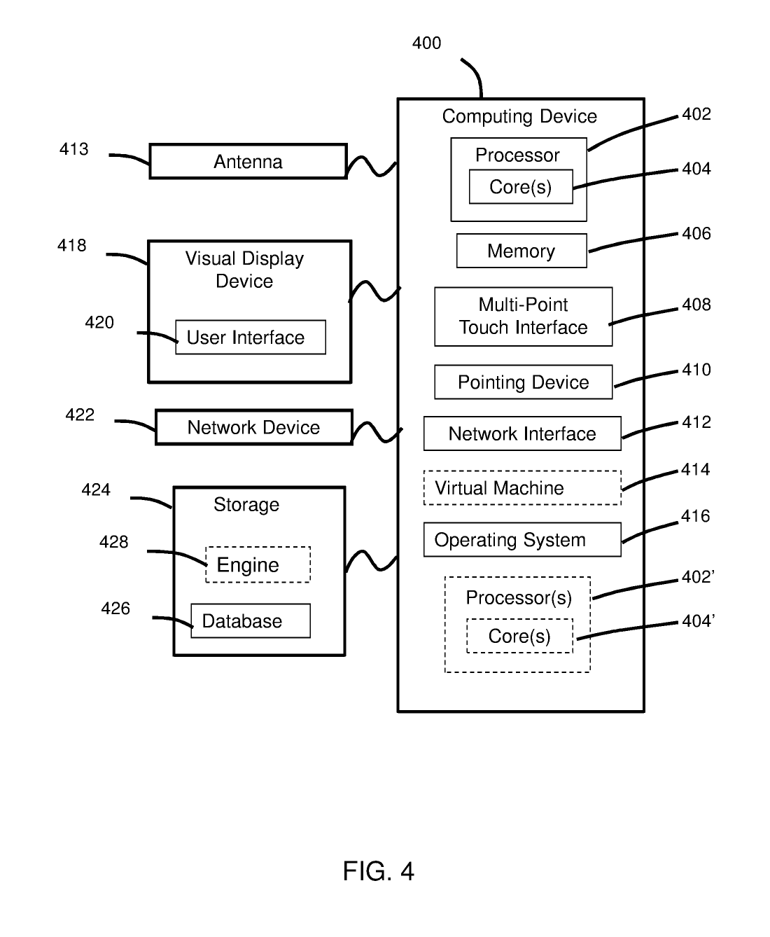

FIG. 3 is a block diagram of an exemplary a distributed environment for implementing a data structure management system in accordance with embodiments of the present disclosure. The environment 300 includes servers 310-314 operatively coupled to one or more mobile devices 321, via a communication network 350, which can be any network over which information can be transmitted between devices communicatively coupled to the network. For example, the communication network 350 can be the Internet, Intranet, virtual private network (VPN), wide area network (WAN), local area network (LAN), and the like. The environment 300 can include repositories or databases 331, which can be operatively coupled to the servers 310-314, as well as to the mobile devices 321, via the communications network 350. The modules 102, 110, 120, 130, and 140 can be implemented on the servers 310-314, respectively. The servers 310-314, mobile devices 321, and databases 331 can each be implemented as a computing device. An exemplary embodiment of a computing device is shown in FIG. 4. Those skilled in the art will recognize that the databases 331 can be incorporated into one or more of the servers 310-314 such that one or more of the servers can include databases.

In exemplary embodiments, the mobile devices 321 can include a client-side application 323 programmed and/or configured to permit the devices 321 to interact with the data structure management system 100. For example, in one embodiment, the client-side application 323 can be a software application programmed and/or including executable code to facilitate interaction with the system 100. The client-side application 323 can be programmed to track a location of the user (e.g., using GPS) relative the boundary defined by execution of the system 100 (e.g., by the server 310) and can be programmed and/or configured to generate and send one or more messages to the system 100 to indicate that the user has entered the boundary and/or that the user intends to pick-up the items in his/her item list. In the present embodiment, the devices 321 can be portable electronic devices configured for wireless communication, such as a tablet, a laptop computer, mobile phone, and/or any other suitable electronic device that permits its location to be identified and/or tracked (e.g., via WiFi, GPS, cellular triangulation, etc.).

The databases 331 can store information for use by the environment 300. For example, the databases 331 can store information related to geographic boundaries, distributed system layout information, item lists, presence of users located within or outside of a boundary as well as other any other information for implementing the data structure management system in accordance with the present disclosure.

In exemplary embodiments, the mobile devices 321 of a user can detect and share user location information using any proximity based technology, for example, but not limited to Geo fencing or Beacon Bluetooth Low Energy (BLE), and share the pre-existing Electronic shopping list (ESL) information on the mobile device 321 with the server 310 either via the wireless networks or device data networks. The server 310 may respond to detecting the interaction or other type of event, by accessing the layout information as a service from the layout module 120, which may be remotely located or resident on server 312.

The server 310 can send the layout information from layout module 120 implemented by the server 312, and item availability information from availability module 130 implemented by the server 313, to the mobile device 321 at the facility location. Furthermore, in an example application, based on the item availability information, the server 310 can modify the user's ESL order information in the management module 140 implemented by the server 314 by adding the unavailable items to a pending order. Additionally, based on the layout information from server 312, item unavailability information from the server 313, and the identified user information and user's pre-configured preferences one or more actions can be taken for unavailable items. As a non-limiting example, the information can include shipping address, credit card information, etc., from the server 314, and an action can be taken by the server 310 to place an order in the server 314 by adding the unavailable items to the online shopping cart and can also additionally check out the items by shipping to the preferred address and charging the credit card from the user's preferences on the account.

FIG. 4 is a block diagram of an exemplary computing device 400 that may be used to implement an exemplary distributed system that includes an embodiment of the data structure management system 100. The computing device 400 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 406 included in the computing device 400 may store computer-readable and computer-executable instructions or software for implementing exemplary embodiments of the system 100. The computing device 400 also includes configurable and/or programmable processor 402 and associated core 404, and optionally, one or more additional configurable and/or programmable processor(s) 402′ and associated core(s) 404′ (for example, in the case of computer systems having multiple processors/cores), for executing computer-readable and computer-executable instructions or software stored in the memory 406 and other programs for controlling system hardware. Processor 402 and processor(s) 402′ may each be a single core processor or multiple core (404 and 404′) processor.

Virtualization may be employed in the computing device 400 so that infrastructure and resources in the computing device may be shared dynamically. A virtual machine 414 may be provided to handle a process running on multiple processors so that the process appears to be using only one computing resource rather than multiple computing resources. Multiple virtual machines may also be used with one processor.

Memory 406 may include a computer system memory or random access memory, such as DRAM, SRAM, EDO RAM, and the like. Memory 406 may include other types of memory as well, or combinations thereof.

A user may interact with the computing device 400 through a visual display device 418, such as a computer monitor, which may display one or more user interfaces 420 that may be provided in accordance with exemplary embodiments. The computing device 400 may include other I/O devices for receiving input from a user, for example, a keyboard or any suitable multi-point touch interface 408, a pointing device 410 (e.g., a mouse). The keyboard 408 and the pointing device 410 may be coupled to the visual display device 418. The computing device 400 may include other suitable conventional I/O peripherals.

The computing device 400 may also include one or more storage devices 424, such as a hard-drive, CD-ROM, or other computer readable media, for storing data and computer-readable instructions and/or software that implement exemplary embodiments of the system 100 described herein. Exemplary storage device 424 may store computer-readable and computer-executable instructions or software, such as control engines 428, for implementing exemplary operations of the data structure management system 100. Exemplary storage device 424 may also store one or more databases for storing any suitable information required to implement exemplary embodiments. For example, exemplary storage device 424 can store one or more databases 426 for storing information, such as geographic boundaries, lists of items, item availability, item locations, facility layout information, presence of users located within or outside of a boundary as well as other any other information for implementing the order updating process in accordance with the present disclosure. The databases may be updated manually or automatically at any suitable time to add, delete, and/or update one or more items in the databases.

The computing device 400 can include a network interface 412 configured to interface via one or more network devices 422 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections (including via cellular base stations), controller area network (CAN), or some combination of any or all of the above. In exemplary embodiments, the computing device 400 can include one or more antennas 413 to facilitate wireless communication (e.g., via the network interface) between the computing device 400 and a network. The network interface 412 may include a built-in network adapter, network interface card, PCMCIA network card, card bus network adapter, wireless network adapter, USB network adapter, modem or any other device suitable for interfacing the computing device 400 to any type of network capable of communication and performing the operations described herein. Moreover, the computing device 400 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 400 may run any operating system 416, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 416 may be run in native mode or emulated mode. In an exemplary embodiment, the operating system 416 may be run on one or more cloud machine instances.

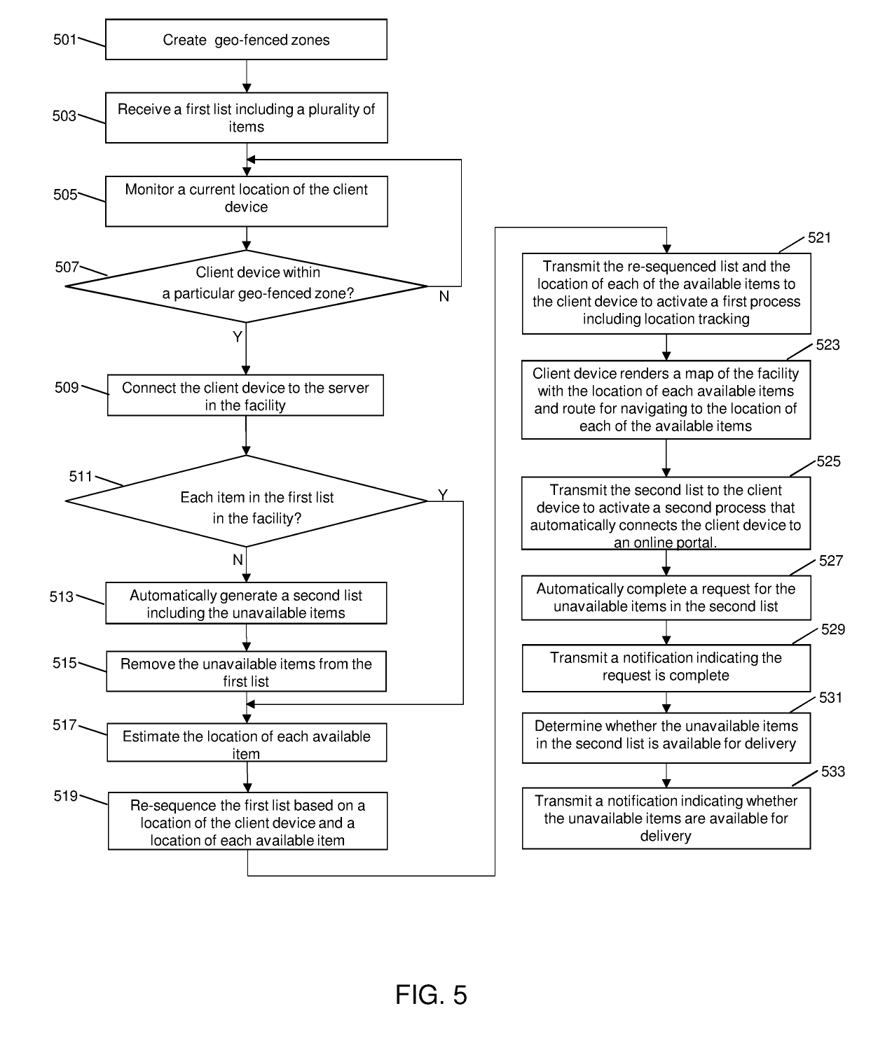

FIG. 5 is a flowchart illustrating an exemplary process implemented by a data structure management system in accordance with embodiments of the present disclosure. At step 501 the data structure management system creates geo-fenced zones for facilities, for example, distributed systems, or portions in a distributed system. At step 503 the system receives a first list that is specified by a user via a client device and includes a plurality of items. The system can monitor a current location of the client device based on a location signal received by the system from the client device at step 505. Then at step 507 the system can determine whether the client device associated with the user is within a particular geo-fenced zone associated with a particular facility based on the location signal received by the system from the client device. If not, the process will go back to step 505 where the system will continue monitoring the current location of the client device. If at step 507 it is determined that the client device is within the particular geo-fenced zone, the system can connect the client device to the server in the particular facility at step 509.

At step 511 the system further determines whether each item in the first list is available in the particular facility. If all the items in the first list are available in the particular facility, the process goes to step 517. If at step 511 it is determined that there are unavailable items in the first list, the system can automatically generate a second list including the unavailable items at step 513. The unavailable items are removed from the first list at step 515, and the process goes to step 517, where the system can estimate the location of each available item by accessing layout information of the facility. At step 519 the system can re-sequence the first list to create a re-sequenced list based on the location of the client device and the location of each available item in the particular facility. In some embodiments, the available items in the first list can be re-sequenced based on a distance between the current location of the client device and the location of each available item and the relative location each item on the list to each other item on the list. As one example, the list can be re-sequenced such that the item closest to the current location of the client device becomes the first item on the list and each subsequent item on the list can be in an order that is based on being the closest item to the preceding item on the list. As another example, the item which is closest to the current location of the user with the client device may be re-sequenced as the first item in the re-sequenced list, and after the user arrive the location of the first item in the re-sequenced list, another item that is closest to the user's current location may be re-sequenced again as the first item in the newly re-sequenced list.

At step 521 the system can transmit the re-sequenced list and the locations of available items to the client device to activate a first process on the client device that includes location tracking of each available item in the particular facility on the client device. In response to activation of the first process, at step 523 the client device renders a map of the particular facility with the locations of the available items and route for navigating to the location of each of the available items, and the user can obtain all the available items in the first list.

At step 525 the system transmits the second list to the client device to activate a second process on the client device that automatically connects the client device to another server in the computing system which provides an online portal. Then at step 527 the system can automatically complete, via the online portal, a request for the unavailable items in the second list according to user's preferences, and at step 529 a notification indicating that the request is complete can be transmitted to the client device. At step 531 the system further determines whether the unavailable items in the second list is available for delivery according to the user's preferences. At step 533 a notification indicating whether the unavailable items are available for delivery can be transmitted to the client device.

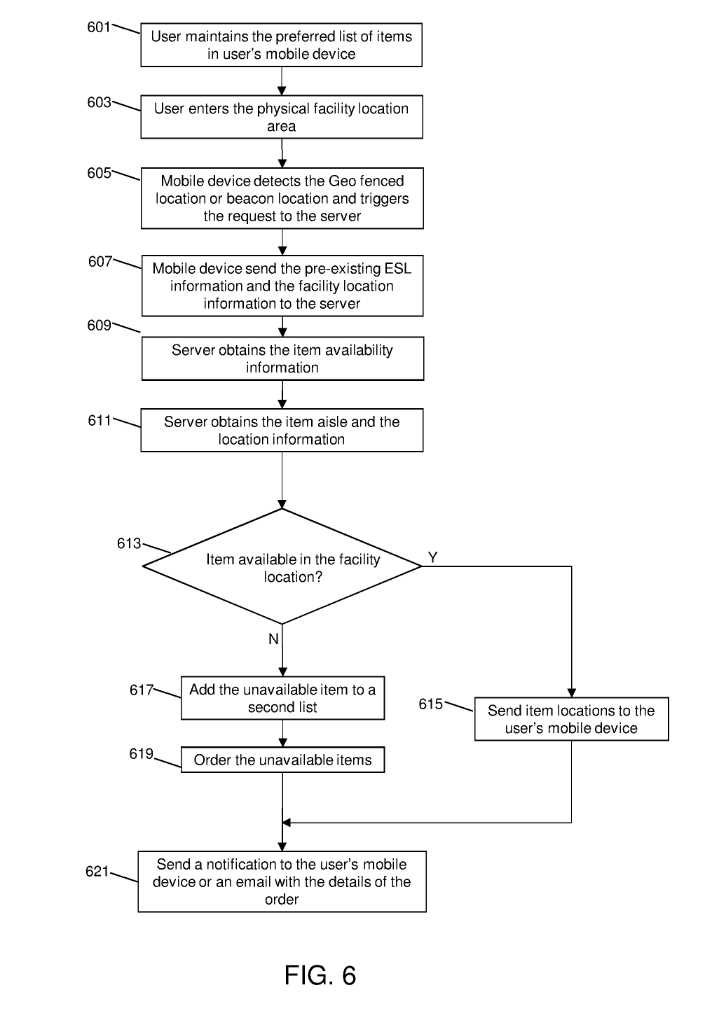

FIG. 6 is a flowchart illustrating another exemplary process implemented by a data structure management system in accordance with embodiments of the present disclosure. At step 601 the user maintains, for example, but not limited to, by scanning or keying in, the desired items with the needed quantities in his/her mobile device. After the user enters the physical facility location area, either in the facility or within the geo fenced location at step 603, the mobile device can detect the geo-fenced location or beacon location and trigger the request to the system via wireless network or cellular data network at step 605. Then at step 607 the mobile device can send the pre-existing ESL information which includes the desired item information, and the facility location information to the system. At step 609 the system can obtain the item availability information from an item database according to the ESL information and the facility location information. At step 611 the system can further obtain the item aisle and the location information from a facility layout map database according to the ESL information and the facility location information.

At step 613 the system can consolidate the item location information and the item availability information and determine whether the desired items are available in the facility. If yes, at step 615 the system can plot the item locations of all the available items on the facility map based on aisle location, and send the item locations to the user's mobile device. Then at step 621 the system can send a notification to the user's mobile device or send an email to the user's account with the details of the online purchase of the available items.

Referring back to step 613, if some desired items are determined as unavailable at this facility location, the system can automatically add the unavailable items to the user's online shopping cart by utilizing the user's preferences which include shipping information, credit card information, etc. Then at step 619, when all the unavailable items have been added to the online shopping cart, the system can automatically place the order of the unavailable items. Alternatively, the system can place the order based on the user's confirmation. Then at step 621 the system can send a notification to the user's mobile device or send an email to the user's account with the details of the order for the unavailable items.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A method for dynamically updating and reordering a list of items based on contemporaneous location data corresponding to a current location of a client device associated with the list of items, the method comprising:
creating, by a computing system, a plurality of geo-fenced zones for a plurality of facilities;
receiving, by the computing system, a first list including a plurality of items, the first list being specified by a user via a client device;
monitoring a current location of the client device based on a location signal received by the computing system from the client device;
determining, by the computing system, that the client device associated with the user is within a first one of the plurality of geo-fenced zones associated with a first one of the plurality of facilities based on the location signal received by the computing system from the client device;
determining whether each of the plurality of items in the first list is in the first one of the plurality of facilities in response to determining that the client device entered the first one of the plurality of geo-fenced zones;
automatically generating, at the computing system, a second list including the unavailable items when at least one of the plurality of items is determined as unavailable in the facility;
removing the unavailable items from the first list;
resequencing the first list to create a re-sequenced list based on a location of the client device and a location of each of the available items in the first one of the plurality of facilities;
transmitting the re-sequenced list and the location of each of the available items to the client device to activate a first process on the client device that includes location tracking of each of the available items in the first one of the plurality of facilities on the client device; and
transmitting the second list to the client device to activate a second process on the client device that automatically connects the client device to an online portal.

2. The method of claim 1, further comprising:
estimating the location of each of the available items by accessing layout information of the facility.

3. The method of claim 1, wherein the available items in the first list are re-sequenced based on a distance between the current location of the client device and the location of each of the available items.

4. The method of claim 1, further comprising:
automatically completing, at the computing system, a request for the unavailable items in the second list according to user's preferences, and
transmitting, to the client device, a notification indicating the request is complete.

5. The method of claim 1, further comprising
determining whether the unavailable items in the second list is available for delivery according to the user's preferences; and
transmitting, to the client device, a notification indicating the unavailable items are available for delivery.

6. The method of claim 1, wherein, in response to activation of the first process, the client device renders a map of the first one of the plurality of facilities with the location of each of the available items and route for navigating to the location of each of the available items.

7. The method of claim 1, wherein the computing system includes a server disposed at each of the plurality of facilities and a central server disposed remotely from the plurality of facilities, and in response to the client device entering the first one of the plurality of geo-fenced zones, the method further comprises:
connecting the client device to the server in the first one of the plurality of facilities.

8. An system for dynamically updating and reordering a list of items based on contemporaneous location data corresponding to a current location of a client device associated with the list of items, the system comprising:
a computing system in communication with a client device, the computing system configured to:
create a plurality of geo-fenced zones for a plurality of facilities;
receive a first list including a plurality of items, the first list being specified by a user via the client device;
monitor a current location of the client device based on a location signal received by the computing system from the client device;
determine that the client device associated with the user is within a first one of the plurality of geo-fenced zones associated with a first one of the plurality of facilities based on the location signal received by the computing system from the client device;
determine whether each of the plurality of items in the first list is in the first one of the plurality of facilities in response to determining that the client device entered the first one of the plurality of geo-fenced zones;
automatically generate a second list including the unavailable items when at least one of the plurality of items is determined as unavailable in the facility;
remove the unavailable items from the first list;
re-sequence the first list to create a re-sequenced list based on a location of the client device and a location of each of the available items in the first one of the plurality of facilities;
transmit the re-sequenced list and the location of each of the available items to the client device to activate a first process on the client device that includes location tracking of each of the available items in the first one of the plurality of facilities on the client device; and
transmit the second list to the client device to activate a second process on the client device that automatically connects the client device to an online portal.

9. The system of claim 8, wherein the computing system is further configured to estimate the location of each of the available items by accessing layout information of the facility.

10. The system of claim 8, wherein the available items in the first list are re-sequenced based on a distance between the current location of the client device and the location of each of the available items.

11. The system of claim 8, wherein the computing system is further configured to:
automatically complete, at the computing system, a request for the unavailable items in the second list according to user's preferences, and
transmit, to the client device, a notification indicating the request is complete.

12. The system of claim 8, wherein the computing system is further configured to:
determine whether the unavailable items in the second list is available for delivery according to the user's preferences; and
transmit, to the client device, a notification indicating the unavailable items are available for delivery.

13. The system of claim 8, wherein, in response to activation of the first process, the client device renders a map of the first one of the plurality of facilities with the location of each of the available items and route for navigating to the location of each of the available items.

14. The system of claim 8, wherein the computing system includes a server disposed at each of the plurality of facilities and a central server disposed remotely from the plurality of facilities, and
in response to the client device entering the first one of the plurality of geo-fenced zones, and the computing system is further configured to connect the client device to the server in the first one of the plurality of facilities.

15. A non-transitory computer-readable medium storing instructions that are executable by a processing device, wherein execution of the instructions by the processing device causes the processing device to:
create a plurality of geo-fenced zones for a plurality of facilities;
receive a first list including a plurality of items, the first list being specified by a user via a client device;
monitor a current location of the client device based on a location signal received from the client device;
determine that the client device associated with the user is within a first one of the plurality of geo-fenced zones associated with a first one of the plurality of facilities based on the location signal received from the client device;
determine whether each of the plurality of items in the first list is in the first one of the plurality of facilities in response to determining that the client device entered the first one of the plurality of geo-fenced zones;
automatically generate a second list including the unavailable items when at least one of the plurality of items is determined as unavailable in the facility;
remove the unavailable items from the first list;
re-sequence the first list to create a re-sequenced list based on a location of the client device and a location of each of the available items in the first one of the plurality of facilities;
transmit the re-sequenced list and the location of each of the available items to the client device to activate a first process on the client device that includes location tracking of each of the available items in the first one of the plurality of facilities on the client device; and
transmit the second list to the client device to activate a second process on the client device that automatically connects the client device to an online portal.

16. The non-transitory computer-readable medium of claim 15, wherein execution of the instructions by the processing device causes the processing device to:
estimate the location of each of the available items by accessing layout information of the facility.

17. The non-transitory computer-readable medium of claim 15, wherein the available items in the first list are re-sequenced based on a distance between the current location of the client device and the location of each of the available items.

18. The non-transitory computer-readable medium of claim 15, wherein execution of the instructions by the processing device causes the processing device to:
automatically complete, at the computing system, a request for the unavailable items in the second list according to user's preferences, and
transmit, to the client device, a notification indicating the request is complete.

19. The non-transitory computer-readable medium of claim 15, wherein execution of the instructions by the processing device causes the processing device to:
determine whether the unavailable items in the second list is available for delivery according to the user's preferences; and
transmit, to the client device, a notification indicating the unavailable items are available for delivery.

20. The non-transitory computer-readable medium of claim 15, wherein, in response to activation of the first process, the client device renders a map of the first one of the plurality of facilities with the location of each of the available items and route for navigating to the location of each of the available items.

21. The non-transitory computer-readable medium of claim 15, wherein the computing system includes a server disposed at each of the plurality of facilities and a central server disposed remotely from the plurality of facilities, and
wherein in response to the client device entering the first one of the plurality of geo-fenced zones, execution of the instructions by the processing device causes the processing device to connect the client device to the server in the first one of the plurality of facilities.
